(19) United States
(12) Patent Application Publication
(10) Pub. No.: US 2002/0188573 A1
(43) Pub. Date: Dec. 12, 2002

(54) Universal electronic tagging for credit/debit transactions

(76) Inventor: Gordon W. Calhoon, South Bend, IN (US)

Correspondence Address: FAY, SHARPE, FAGAN,, MINNICH & McKEE, LLP, 1100 Superior Avenue, Seventh Floor, Cleveland, OH, 44114-2518, US

(21) Appl. No.: 10/041,437

(22) Filed: Jan. 8, 2002

Related U.S. Application Data
(60) Provisional application No. 60/260,354, filed on Jan. 8, 2001.

(51) Int. Cl. G06F 17/60

(52) U.S. Cl. 705/64

(57) ABSTRACT

A method of conducting secure transactions over a communications network (50) includes registering members. The registered members (30) are each assigned a unique user ID and have a financial account associated therewith. Registered members (30) connected to the communications network (50) are logging in with their unique user ID, and assigned a unique session code. The method further includes receiving purchase authorization requests from merchants (20). Each of the purchase authorization requests indicates a purchase amount and a session code. The validity of session codes indicated in received purchase authorization requests are then verified.

This application claims the benefit of and hereby expressly incorporates by reference Provisional U.S. patent application Ser. No. 60/260,354 filed Jan. 8, 2001.

### BACKGROUND OF THE INVENTION

The present invention relates to Internet technology. It finds particular application in conjunction with the processing of Internet credit card transactions, and will be described with particular reference thereto. However, it is to be appreciated that the present invention is also amenable to other like applications, such as, debit card transactions, the transactional exchange of information, etc.

Internet commerce, otherwise known as electronic commerce or e-commerce, relates to the buying and selling of products and services or the transactional exchange of information over the Internet. The convenience of shopping over the Internet has sparked considerable interest in e-commerce on behalf of both buyers and sellers. Internet sales or like transactions have been typically carried out using standard credit cards such as Visa®, MasterCard®, Discover®, American Express®, or the like. On-line companies and other institutions have issued other credit cards that are also commonly used.

Although widely used for signature-based and/or face-to-face transactions, the electronic use of credit cards for on-line payment in connection with e-commerce transactions can be less secure. E-commerce transactions have heretofore experienced limited methods of authentication and limited security for the electronic storage and transmission of transaction data, card numbers, personal information and other sensitive data. Uncertainty regarding identity creates apprehension concerning the validity of a purchase on the part of the seller and concern for the security of their credit card number and personal information on the part of the purchaser.

While widely used for more traditional face-to-face transactions, use of credit cards in connection with e-commerce transactions presents certain difficulties. The fact that e-commerce transactions are not carried out face-to-face often creates apprehension for a potential buyer. This apprehension is fueled by uncertainty of the reputation or quality of the seller with whom they are dealing and the security of their credit card information or other personal information (e.g., address, credit card number, phone number, etc.), which are typically submitted along with a traditional Internet credit card transaction. Credit card account holders, sellers and financial issuing institutions are concerned about safeguards against fraudulent and unauthorized credit card transactions, security of electronically stored data and secure transport of data over the Internet.

The present invention contemplates a new technique for carrying out credit card transactions over the Internet that overcomes the above-referenced problems as well as others.

### SUMMARY OF THE INVENTION

In accordance with one aspect of the present invention, a method of conducting secure transactions over a communications network is provided. The method includes registering members. The registered members are each assigned a unique user ID and have a financial account associated therewith. Registered members connected to the communications network are logging in with their unique user ID, and assigned a unique session code. The method further includes receiving purchase authorization requests from merchants. Each of the purchase authorization requests indicates a purchase amount and a session code. The validity of session codes indicated in received purchase authorization requests are then verified.

In accordance with another aspect of the present invention, a transaction processing system for authorizing purchases over a communications network includes a server by which a presence is maintained on the communications network. Registration means are used to register members to use the transaction processing system. The registration means establishes unique user IDs for each registered member and associates respective financial accounts therewith. Log-in means log in registered members using the communications network. The logged in members are identified by their respective user IDs. Tagging means are used to assign a unique session code to each logged in member, and receiving means are used to receive purchase authorization requests from merchants. Each of the purchase authorization requests indicates a purchase amount and a session code. Validating means then verify the validity of session codes indicated in received purchase authorization requests.

One advantage of the present invention is that Internet credit card transactions are securely carried out.

Another advantage of the present invention is that buyers and sellers are protected from fraudulent or otherwise unauthorized transactions.

Still further advantages and benefits of the present invention will become apparent to those of ordinary skill in the art upon a reading and understanding of the following detailed description of the preferred embodiments.

### BRIEF DESCRIPTION OF THE DRAWINGS

The present invention may take form in various components and arrangement of components, and in various steps and arrangements of steps. The drawings are only for purposes of illustrating preferred embodiments and are not be construed as limiting the invention.

FIG. 1 is a flow chart showing a high level overview of an online transaction processing system using an electronic identification tag in accordance with aspects of the present invention.

FIG. 2 is a diagrammatic illustration showing Internet connected participants in an online transaction processing system in accordance with aspects of the present invention.

FIG. 3 is a flow chart showing a process for registering members for participation in an online transaction processing system in accordance with aspects of the present invention.

FIG. 4 is a flow chart showing a process for a member to log into an online transaction processing system and be validated thereby in accordance aspects of the present invention.

FIG. 5 is a flow chart showing an online shopping process carried out with an online transaction processing system in accordance aspects of the present invention.

FIG. 6 is a flow chart showing a settlement process carried out with an online transaction processing system in accordance aspects of the present invention.

### DETAILED DESCRIPTION OF THE PREFERRED EMBODIMENTS

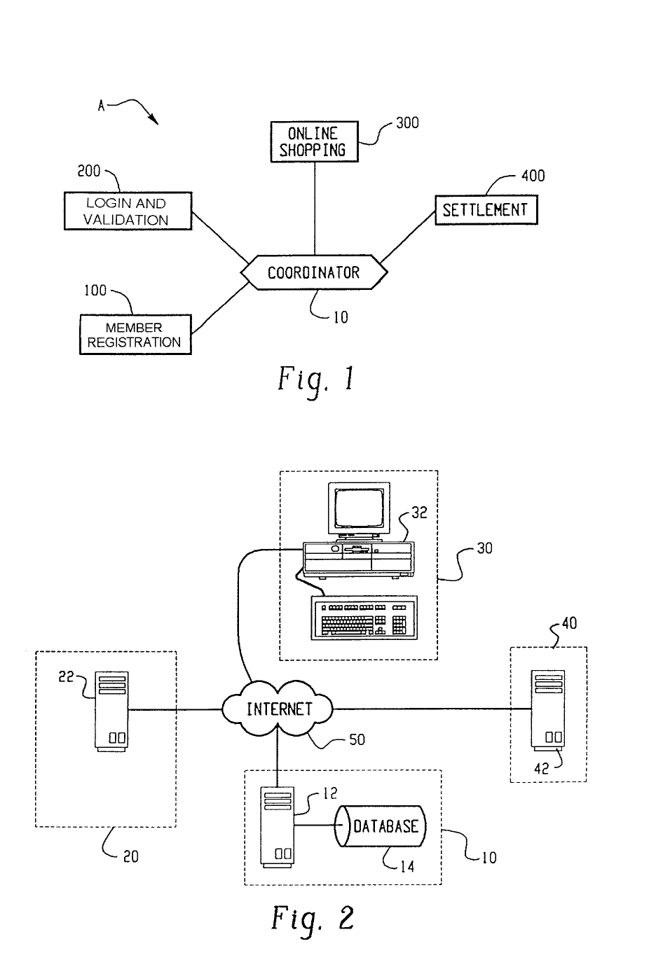

With reference to FIG. 1, a central transaction coordinator 10 administers a number of different yet inter-dependent processes in a commercial Internet credit/debit transaction processing system A. The processes administered by the coordinator 10 include: (i) a member registration process 100 wherein consumers are signed up as account holders for participation in the transaction processing system; (ii) a login and validation process 200 wherein registered members are logged in and their identities validated; (iii) an online shopping process 300 wherein members engage in online commercial transactions with participating merchants or sellers; and, (iv) a settlement process 400 wherein completed commercial transactions are confirmed and settled via a funding source. Optionally, the coordinator 10 itself acts as the funding source. However, in the interest of simplicity and clarity, in the following description, the discussion is directed to embodiments employing a third party funding source.

With further reference to FIG. 2, in a preferred embodiment, the coordinator 10 maintains a presence on the Internet 50 or other like online network via a server 12. A merchant or seller 20 also maintains a presence on the Internet 50 via a server 22. A buyer or account holder 30 gains access to the seller 20 and/or the coordinator 10 over the Internet 50 using a computer 32 with an appropriate web browser or other like software running thereon. Of course, the transaction processing system A is preferably administered to multiple similarly situated sellers 20 and buyers 30. However, in the interest of simplicity herein, only a one of each are shown in FIG. 2. Additionally, a funding source 40 maintains a presence on the Internet 50 via a server 42. The funding source 40 extends credit for credit accounts or holds deposits for debit accounts created on behalf of account holders participating in the transaction processing system A. Moreover, it is to be appreciated that the security of the transaction processing system A is further enhanced by encrypting, with known encryption techniques, communications relayed or otherwise transmitted over the Internet 50.

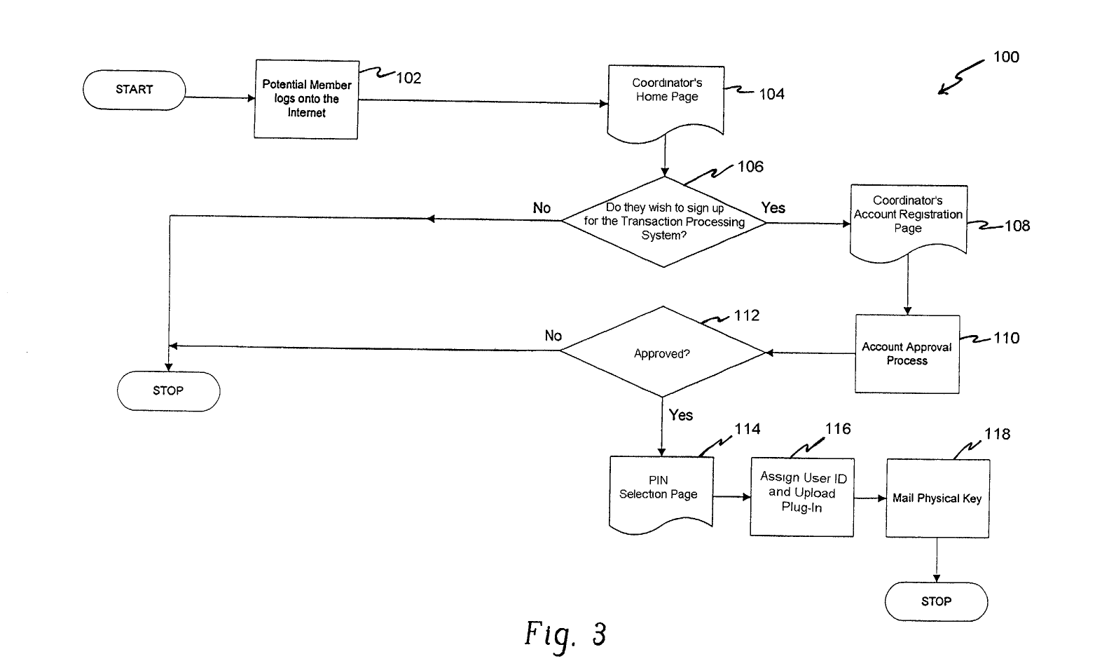

With reference to FIG. 3, the process 100 by which a buyer 30 becomes registered with the coordinator 10 is disclosed. The process 100 begins at step 102 with the user or buyer 30 logging onto the Internet 50 and visiting the website or home page 104 of the coordinator 10. Via the coordinator's website, the buyer or consumer 30 is asked if they wish to participate in the system A. At decision step 106, if the response is positive or yes, the individual is routed to the coordinator's registration page 108. Otherwise, if the response is negative or no, the process 100 is ended.

Access to the registration page 108 is made available via the coordinator's server 12. Using the registration page 108, the individual's registration data (e.g., name, address, length at residence, rent or own residence, e-mail address, home phone number, work phone number, social security number, date of birth, mother's maiden name, employer, income, employment status, etc.) is collected or otherwise obtained by the coordinator 10 from the buyer or the potential new member who is applying for participation in the transaction processing system A. The registration data, preferably, also includes account information (account number, card number, card expiration data, billing address, account type, etc.) related to the financial account the potential new member wishes to have associated with their registration. Preferably, when the registration data is received, it is automatically changed by an algorithm to random number code sets or otherwise encrypted for security. The random number code sets or encrypted data are electronically stored in a secure database 14 (see FIG. 2). Providing the account information at registration does not constitute a purchase.

An automated account approval process 110 ensures that the applicant is an authorized user of the credit card, debit card, or other financial account identified in the registration data. Optionally, the automated account approval process 100 includes, but is not limited to, one or more of the following: authorization and void transaction pairs (where a small charge is authorized, then immediately voided), address verification, verbally authenticating the applicant, or referral of the registration information to the issuing financial institution or funding source 40 for verification. These verification steps may occur at the time of application or at a later date. The coordinator 10 may choose to authorize a limited number of transactions (or funds) to be processed until further authentication can take place. Provided the registering individual is authorized to use the financial account, they are approved otherwise they are denied.

At decision step 112, if approval process indicates that the individual is not approved, the process 100 ends. Otherwise, if the individual was approved, they are provided with a personal identification number (PIN) selection page 114.

Along with an indication of acceptance, the PIN selection page 114 is used to collect the new member's preferred secret PIN. The new member 30 may also supply the coordinator 10 with additional account creation data that is then stored (optionally, encrypted) with their registration data. That is, upon acceptance, the coordinator 10 creates a record for the new member in the coordinator's database 14. The record includes the registration data, approval data, approval information, acceptance, and additional data related to the new member.

At step 116, the coordinator 10 also assigns the member 30 an associated user identity (ID), e.g., a self-selected user name, or an otherwise assigned alphanumeric designation, which is unique to the member 30 and becomes part of the member's record. The user ID is encrypted and transmitted to the member's computer 32 along with a computer program such as a browser plug-in or other program. This program is used to respond to and accept information from both the coordinator 10 and participating merchants 20.

Additionally, at step 118, the coordinator 10 mails, or otherwise delivers, a physical key to the new member 30. Preferably, the key takes the form of a CDROM, a floppy disk, or some other electronic equipment that interfaces directly with a computer. The physical key allows the member 30 to use the transaction processing system A with computers other than their primary computer, i.e., the computer 32 that was used for registration. Accordingly, the member 30 is able to access the system A from remote locations. In this case, the coordinator 10 will ask for verification of the member's identity by asking for the physical key. This is accomplished by placing the physical key (either CD-ROM or floppy-disk or some other media device) within a drive of the computer to be read by the coordinator 10. Once verification of possession of the physical key takes place, the member 30 is approved to access the account previously created.

The plug-in or (or key) is used to establish an application program interface (API) on the client machine for communication and authentication purposes. For example, this may be a COM component for PC-based users. The plug-in is used to automatically authenticate the client machine/computer which was used in the registration process 100, alternately the key allows the member 30 to be authenticated from any client. To avoid unauthorized use of the machine a separate password or PIN is required to activate the plug-in or key. Further, the plug-in or key, which ever is being used, acts as a session “keep alive” for each individual client session. It provides a constant communication between the client and server 12, even if the client accesses a different server. The plug-in/key maintains a unique tag code or session code that is issued and which is unique for each individual client session. This code is issued at the sign-on of each individual session and is valid for no more than a single session. As each session ends, the data link will delete and no longer recognize this unique session code.

In particular, with respect to the key, it is optionally a physical card that may be of the same size as a standard credit card with numbers and the client's name. This card can be read, for example, by a disc drive and is used for user authentication when the client is accessing the transaction processing system A from a foreign machine. The drive controller programming is on the card. Alternatively, the physical key may take the shape and form of existing computer media, such as a CD-ROM or floppy disk or the like. When the key is used, it activates and loads a window on the monitor to enter a PIN or password. Preferably, all entries appear as asterisks.

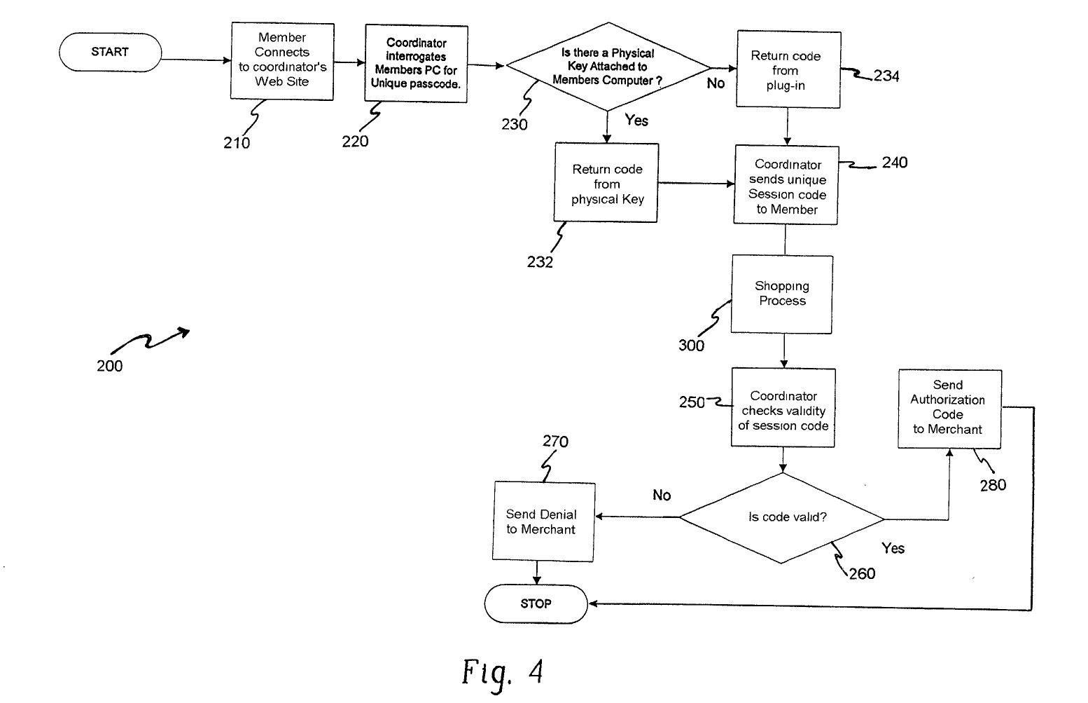

With further reference to FIG. 4, an exemplary login and validation process 200 is shown by way of the illustrated flow chart. The process 200 begins at step 202 with a member 30 contacting the coordinator 10 (e.g., accessing the coordinator's online or Internet shopping portal using an appropriate web browser) or otherwise requesting a web page from or linking to the coordinator's server 12. At step 220, the member's computer is then interrogated by the coordinator 10 for the member's unique user ID in addition to obtaining the member's secret PIN.

At this point, the coordinator 10 identifies some physical aspect of what the member 30 has in their possession. At decision step 230, it is determined it if there is a physical key attached to the member's computer. If the determination is yes or positive, then user ID is obtained from the key at step 232. Otherwise, if the determination is no or negative, then the user ID is obtained from the computer at step 234 via the plug-in which was installed previously on the member's computer at registration.

At step 240, after the member 30 has been positively identified, a unique, electronic session identification number or code is generated and is made available to the plug-in or key operating on the member's client machine or computer. This session identification number or code is unique to the period of time that the member 30 is accessing the Internet 50 contiguously or for a specified period of time. The coordinator 10 determines when this session identification number or code is no longer authorized for purchases. This determination is based on a variety of factors that include, but are not limited to, one or more of the following: the time since assignment, the ability of the coordinator 10 to communicate with the plug-in/key on the member's computer (i.e., the existence of a session link therebetween, recall that the plug-in/key act as a session keep alive), the number of purchases made, the dollar amount of the purchases made, etc. Each session code corresponds to a particular logged-in member 30.

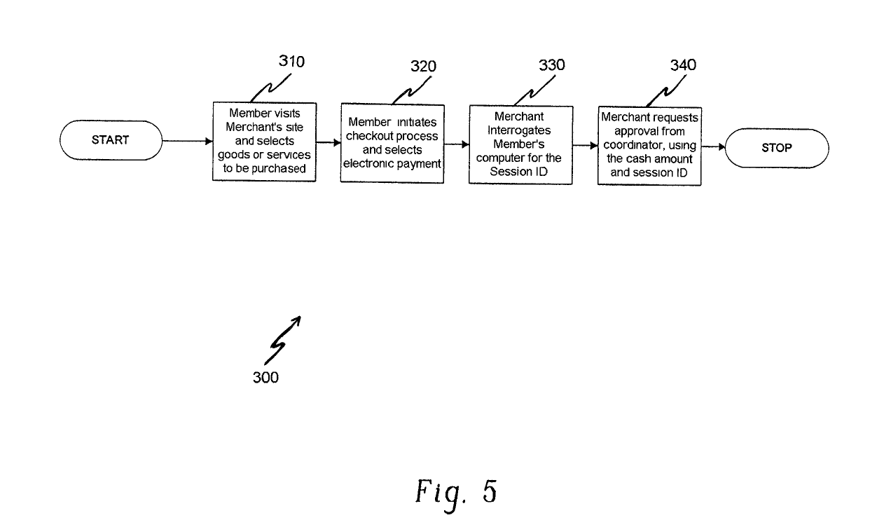

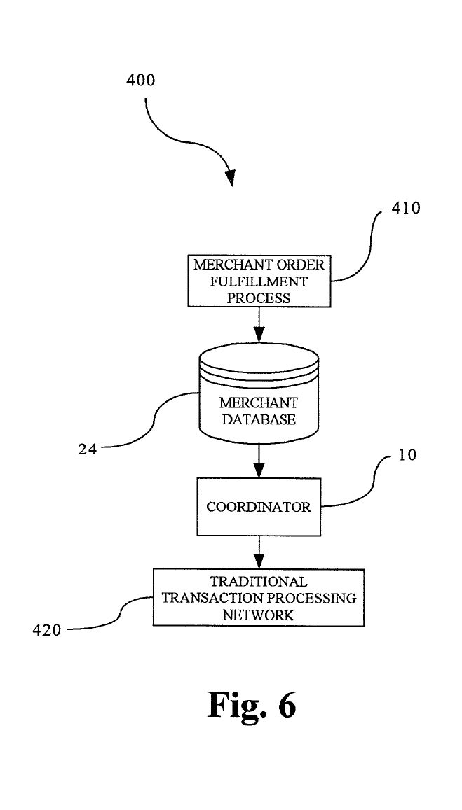

The member 30, having logged in, is now free to shop on-line a participating merchants in accordance with the exemplary shopping process 300 shown in FIG. 5. Again, even as the member 30 surfs to different web sites and/or connects with different merchant servers 22, the session link between the member 30 and the coordinator 10 is maintained via the plug-in/key's keep alive function. Additionally, the session is assigned a unique session code identifying the same.

With particular reference now to FIG. 5, at step 310, the member visits a participating merchant's Internet site. Optionally, member 30 may requests, or the coordinator's server 12 otherwise displays, a web page or the like with a shopping directory listing participating merchants or vendors 20 that are registered with and/or use the transaction processing system A administered by the coordinator 10. The member 30 is then free to select the participating seller 20 of his choice and shop as desired.

At the merchant's site, the member 30 selects goods and/or services which are desired for purchasing in the normal manner. Preferably, these goods or services are then placed into a virtual shopping cart or some similar mechanism for tracking selected merchandise. If the member 30 desires to select more products from the merchant, the process loops back to the product selection of the merchant's site and/or other like shopping web pages made available from via the merchant's server 22. On the other hand, when the shopping is completed, the process 300 continues on to step 320 where the member 30 initiates checkout and optionally selects the form of electronic payment.

Preferably, participating merchants 20 are suitably screened for participation in the system A and are set up to handle purchases by members 30. That is to say, they have software running on their serves 22 that either automatically detect and identify session codes on member's client machines or computers used to access their shopping site, or provide object links on their check out pages that allow members 30 to select checking out with the system A. For example, participating merchants may be issued a software component that will upon check out recognize the unique session identification tag code, load a generated data entry page, process the information, and then transmit it to the coordinator 10 for approval. Preferably, the loaded page does not require entry of any member registration information, only shipping information is required. Member merchants are also issued an account number code that is generated by an algorithm from their merchant bank account number. This code is used for payment. Further, the account may also be decoded by the coordinator 10. Alternately, the session code is used only when the member 30 accesses the transaction object or link previously established on the participating merchant's check-out page. In this manner, the member 30 may choose to conduct transaction outside of the system A even when they are in fact logged-in.

In any event, at step 330, the merchant's server 22 interrogates the accessing computer for the session code. That is to say, the session code is retrieved from the plug-in or key operating on the member's computer. This session code is then used by the merchant to authorize the transaction with the coordinator 10. That is to say, at step 340, the merchant 20 requests approval for the purchase from the coordinator 10 by forwarding to the coordinator 10 the obtained session identification code and the purchase amount.

Referring again to FIG. 4, the coordinator 10 receives the merchant's request for approval of a purchase. In response thereto, at step 250, the coordinator 10 checks validity of session code to thereby authenticate the member 30. The coordinator 10 cross-references the unique session identification code back to the member that it was originally granted to. Optionally, the coordinator 10 verifies the code by checking to see that the session link to that member 30 is still alive. Additionally, the coordinator 10 may verify that the member's financial account has sufficient funds or credit to complete the purchase. This may be carried out by forwarding the purchase amount to the funding source 40 holding the particular financial account and receiving verification back therefrom that the necessary funds or credit are available. Alternately, the financial account's available balance or available credit may be queried from the funding source 40, or the status of the member's financial account may also be maintained along with the member's record in the coordinator's database 14 such that the coordinator 10 may directly authorize transactions.

At decision step 260, it is determined whether or not the session code is valid and the purchase is authorized. If the determination is no or negative, at step 270 a denial code is preferably sent back to the merchant 20 and the process 200 ends. Otherwise, if the determination is yes or positive, at step 280 an authorization code is preferably sent back to the to merchant 20. That is to say, upon determining authorization (in the affirmative or in the negative), a corresponding authorization/denial code is established for the transaction. Preferably, the authorization code along with the authorization result and the corresponding transaction details are maintained in a transaction record, which may be optionally electronically stored in the coordinator's database 14. Additionally, an indication of the authorization outcome and the authorization code are communicated to the participating merchant 20 and optionally also to the member 30.

Optionally, provided authorization is complete and successful, the coordinator 10 may also communicate transaction fulfillment data along with the authorization code. The transaction fulfillment data includes information given by the member 30 at registration, which is to be used by the participating merchant 20 to fulfill their obligations(s) to the member 30 for the commercial transaction in which they are engaged. The transaction fulfillment data preferably includes one or more of a delivery destination for the items selected for purchase in the transaction, a desired shipping carrier, preferred shipping time, etc. For example, for physical goods the delivery destination may be a shipping address, or for downloaded content, downloaded software, digital goods or services, and other like items, the delivery destination may be an e-mail address or the member's networked computer 32. In either case, this option also the member 30 to purchase goods without having to provide that information directly to the merchant 20 each time.

Optionally, authentication and authorization may be conducted separately. For example, the member 30 may first be authenticated via validation of the session code. Then they may make a selection, if any, with regard to shipping destination, shipping carrier and/or preferred shipping time. The transaction details can then be transmitted from the merchant 20 to the coordinator 10 where they are received for authorization processing. The transaction details preferably include the total cost (with tax and shipping) for the selected items being purchased in the transaction. Additionally, the transaction details identify the participating merchant 20 and the member 30.

With reference to FIG. 5, the settlement process 400 for completing commercial transactions begins with the merchant's order fulfillment process 410. Preferably, the settlement process 400 occurs periodically, e.g., daily, weekly, etc. The fulfillment process 410 is prompted by or otherwise involves the delivery of ordered goods and/or services. At that time, the fulfillment process 410 sends an order status update to the merchant's database 24. The coordinator 10 obtains or otherwise receives settlement data from the database 24. Optionally, the merchant 20 may route settlement data directly to the coordinator 10 or the coordinator automatically extract settlement information from the merchant 30. For example, with regard to the automatic extraction of settlement information, when a merchant's delivery process is executed, thereby delivering purchased goods or services to the member, a merchant's inventory database or other such merchant database 24 is accordingly updated to indicate delivery and completion of the particular transaction. In the settlement procedure then, settlement information corresponding to those transactions indicated in the merchant's database 24 as having been completed is automatically retrieved by the coordinator 10 from the database 24.

The communication of settlement information indicates that the merchant 20 has fulfilled his obligations to the member 30 in connection with the particular authorized commercial transaction. The obtained settlement information preferably includes the authorization code and the corresponding transaction details for the transaction in question. The coordinator 10 then correlates the settlement information to the corresponding transaction record having the same authorization code to confirm or otherwise validate and approve settlement when the transaction details in the settlement information are substantially the same as the transaction details in the transaction record. In particular, the total cost from the transaction details reported in the settlement information is optionally permitted to vary within a given tolerance from the total cost contained in the transaction details of the transaction record. In the cases where there is an insufficient match, the settlement information is returned to the merchant 20 as rejected. In a preferred embodiment, the coordinator 10 will periodically (e.g., at the end of each day), communicate the confirmed settlement information to the issuing financial institutions, over the Internet or other communications network. Settlement can then be completed using the traditional transaction processing network 420.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiments, the invention in now claimed to be:

1. A method of conducting secure transactions over a communications network, the method comprising:
(a) registering members, said registered members each being assigned a unique user ID and having a financial account associated therewith;
(b) logging in registered members connected to the communications network with their unique user ID;
(c) assigning logged in members a unique session code;
(d) receiving purchase authorization requests from merchants, each of said purchase authorization requests indicating a purchase amount and a session code; and,
(e) verifying the validity of session codes indicated in received purchase authorization requests.

2. The method according to claim 1, wherein each unique session code is only valid while the respective member is logged in for a particular session.

3. The method according to claim 1, further comprising:
(f) determining if the respective financial account is sufficient to cover the purchase amount indicated in its corresponding purchase authorization request.

4. The method according to claim 3, wherein if the session code is valid and the respective account is determined to be sufficient to cover the purchase amount, then in response to the purchase authorization request, the method further includes:
(g) establishing an authorization code, said authorization code being communicated to the merchant from which the purchase authorization request was received.

5. The method according to claim 1, wherein a persistent communication link is established when a member is logged in, such that when the communication link is terminated the unique session code associated therewith is no longer valid.

6. The method according to claim 5, wherein the persistent communication link is maintained so long as the member is logged in.

7. The method according to claim 5, wherein the persistent communication link is not broken when the member accesses other sites on the communications network.

8. A transaction processing system for authorizing purchases over a communications network, said system comprising:
a server by which a presence is maintained on the communications network;
registration means for registering members to use the transaction processing system, said registration means establishing unique user IDs for each registered member and associating respective financial accounts therewith;
log-in means for logging in registered members using the communications network, said logged in members being identified by their respective user IDs;
tagging means for assigning a unique session code to each logged in member;
receiving means for receiving purchase authorization requests from merchants, each of said purchase authorization requests indicating a purchase amount and a session code; and,
validating means for verifying the validity of session codes indicated in received purchase authorization requests.

9. The transaction processing system according to claim 8, wherein each unique session code is only valid while the respective member is logged in for a particular session.

10. The transaction processing system according to claim 8, further comprising:
determining means for determining if the respective financial account is sufficient to cover the purchase amount indicated in its corresponding purchase authorization request.

11. The transaction processing system according to claim 10, further including authorizing means wherein if the session code is valid and the respective account is determined to be sufficient to cover the purchase amount, then in response to the purchase authorization request, the authorizing means establishes an authorization code, said authorization code being communicated to the merchant from which the purchase authorization request was received.

12. The transaction processing system according to claim 8, wherein a persistent communication link is established by the log-in means when a member is logged in, such that when the communication link is terminated the unique session code associated therewith is no longer valid.

13. The transaction processing system according to claim 12, wherein the persistent communication link is maintained so long as the member is logged in.

14. The transaction processing system according to claim 12, wherein the persistent communication link is not broken when the member accesses other sites on the communications network.

15. The transaction processing system according to claim 8, wherein the tagging means communicates the unique session IDs to the respective logged in members such that they can be communicated to merchants from the members shopping at merchant sites maintained on the communications network.
